(19) United States
(12) Patent Application Publication
(10) Pub. No.: US 2004/0165497 A1
(43) Pub. Date: Aug. 26, 2004

(54) Decoder having analog PLL circuit and digital PLL circuit

(76) Inventor: Hideki Hirayama, Hashima-shi (JP)

Correspondence Address: FISH & RICHARDSON PC, 225 FRANKLIN ST, BOSTON, MA, 02110, US

(21) Appl. No.: 10/783,500

(22) Filed: Feb. 20, 2004

(30) Foreign Application Priority Data
Feb. 20, 2003 (JP) 2003-042416

(51) Int. Cl. G11B 5/09

(52) U.S. Cl. 369/47.31

(57) ABSTRACT

A decoder for improving efficiency of demodulation of address information, which is recorded by performing phase-modulation on the wobble of a groove. The decoder demodulates the address information based on the phase inversion pattern of an ADIP, which is detected using a first clock signal generated by a digital PLL circuit, until an analog PLL circuit is locked. The decoder demodulates the address information based on the phase inversion pattern of the detected ADIP using a second clock signal, which is generated by the analog PLL circuit, after the analog PLL circuit is locked.

### BACKGROUND OF THE INVENTION

The present invention relates to decoders, and more specifically, to a decoder for demodulating address information, installed within a data recording controller and used in, for example, recording control of a disc medium.

Recently, disc-type recording media, such as an optical disc, are becoming more popular. Such disc media include data recordable disc medium. For example, there are optical discs such as a Digital Versatile Disc+Recordable (DVD+R), and a Digital Versatile Disc+ReWritable (DVD+RW) (hereinafter referred collectively as DVD+R/RW).

An optical disc such as DVD+R/RW has a groove formed on a flat surface (land) thereof, and the groove forms a track. The groove is slightly meandered (wobbled), and a wobble signal (a signal in which the voltage changes in accordance with the meandering direction of the groove) having a predetermined cycle is extracted from such meandering. The wobble of the groove is formed so as to correspond to the data recording region set in accordance with a predetermined data length based on the recording format of the disk.

The DVD+R/RW has a data format in which 1 sector consists of 26 frames (93 bytes), and a recording format in which 93 cycles of the wobble signal is assigned to 2 frames. Furthermore, in the DVD+R/RW, an Address in Pregroove (ADIP) that can represent the physical positional information (address information) on the disc is produced by performing phase-modulation on a wobble component to modulate the phase of the wobble signal.

One ADIP is set for every 2 frames, and the ADIP is recorded by performing phase-modulation on the leading 8 cycles of the 93 cycles of the wobble signal. Therefore, the address information is superimposed on the leading 8 cycles of the wobble signal included in a reproduction signal from the disc medium. The address information is acquired by reading one sector of a reproduction signal, and then combining the ADIP included in the one sector. The position on the disc that the laser is tracing can be found using the address information.

FIGS. 1(a) to 1(c) are waveform charts showing one example of the reproduction signal A in which the phase of the wobble signal is modulated. For example, there are 3 types of phase-modulation patterns, one for SYNC (synchronization), one for a bit value of “0”, and another for a bit value of “1”. Each pattern of the ADIP for one sector is replaced with a corresponding value to generate the data representing the address information.

For example, FIG. 1(a) shows a SYNC (synchronization) pattern, FIG. 1(b) shows a pattern corresponding to the bit value “0”, and FIG. 1(c) shows a pattern corresponding to the bit value “1”. In each figure, “PW” and “NW” represent positive phase and negative phase of the reproduction signal A, respectively. Further, signal B is a reproduction data signal obtained by binary coding the reproduction signal A. The reproduction data signal B includes a wobble data signal (a binary signal of the wobble signal), and the pulse width of the wobble data signal corresponding to the phase inverted part is relatively large.

A decoder demodulates the ADIP superimposed on the wobble signal to address information. The decoder includes for example, an exclusive OR circuit (hereinafter referred to as an EOR circuit), a Phase Locked Loop (PLL) circuit and a demodulator circuit. The PLL circuit generates a clock signal, which is synchronized with the wobble signal, the EOR circuit performs an exclusive OR operation on the clock signal and the wobble signal, and the demodulator circuit demodulates the address information based on the result of such operation.

The PLL circuit is provided with a voltage-controlled oscillator for generating the clock signal, a phase comparator for comparing the clock signal and the wobble signal, and a charge pump and low pass filter for feeding back a voltage signal, in accordance with the phase difference, to the voltage-controlled oscillator to generate the clock signal synchronized with the wobble signal. The EOR circuit performs exclusive OR operation on the clock signal, which is synchronized with the wobble signal, and the wobble signal to detect a phase inversion (or ADIP) of the wobble signal. The demodulator circuit demodulates the address information based on the detected result. The recordation and reproduction of data is carried out based on the address information demodulated in such a way.

In the decoder, the PLL circuit is configured by an analog circuit. The analog PLL circuit generally has a superior phase-noise characteristic but has an inferior tracking characteristic. In other words, it is difficult for the analog PLL circuit to lock the oscillation frequency of the voltage-controlled oscillator with the frequency of the wobble signal at high speed (i.e., to synchronize the clock signal with the wobble signal at high speed). In order to achieve high speed locking, the area of the analog PLL circuit as a whole must be increased, thus causing an increase in the cost.

As mentioned above, the EOR circuit detects the phase inversion of the wobble signal using the clock signal, which is synchronized with the wobble signal and is generated by the PLL circuit. Thus, a delay in the locking time of the PLL circuit reduces efficiency of the demodulation process. This in turn, reduces the response speed during the recordation or reproduction of data.

It is an object of the present invention to provide a decoder having improved efficiency for performing the demodulation process on the address information, which is recorded by phase-modulating the wobble of a groove.

### SUMMARY OF THE INVENTION

One aspect of the present invention is a decoder for demodulating address information using a wobble signal. The decoder includes a digital PLL circuit for generating a first clock signal and synchronizing the first clock signal with the wobble signal based on a difference between the phase of the wobble signal and the phase of the first clock signal. An analog PLL circuit generates a second clock signal and synchronizes the second clock signal with the wobble signal based on a difference between the phase of the wobble signal and the phase of the second clock signal. A demodulator, connected to the digital PLL circuit and the analog PLL circuit, samples the wobble signal using either the first clock signal or the second clock signal to demodulate the address information.

A further aspect of the present invention is a decoder for demodulating address information using a wobble signal. The decoder includes a digital PLL circuit for generating a first clock signal and synchronizing the first clock signal with the wobble signal based on a difference between the phase of the wobble signal and the phase of the first clock signal. An analog PLL circuit generates a second clock signal and synchronizes the second clock signal with the wobble signal based on a difference between the phase of the wobble signal and the phase of the second clock signal. A detection circuit compares the wobble signal and the second clock signal, detects whether the second clock signal is synchronized with the wobble signal, and generates an active select signal when the second clock signal is synchronized with the wobble signal. A demodulator, connected to the digital PLL circuit, the analog PLL circuit, and the detection circuit, samples the wobble signal using the first clock signal to demodulate the address information when the select signal is inactive and samples the wobble signal using the second clock signal to demodulate the address information when the select signal is active.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a waveform chart showing a reproduction signal having a SYNC pattern;

FIG. 1(b) is a waveform chart showing a reproduction signal having a pattern corresponding to a bit value of “0”;

FIG. 1(c) is a waveform chart showing a reproduction signal having a pattern corresponding to a bit value of “1”;

FIG. 2 is a schematic block diagram of a decoder according to one embodiment of the present invention, provided in a data recording controller;

FIG. 3 is a schematic block diagram of an analog PLL circuit of the decoder shown in FIG. 2; and

FIG. 4 is a schematic block diagram of a digital PLL circuit of the decoder shown in FIG. 2.

### DETAILED DESCRIPTION OF THE PREFERRED EMBODIMENTS

In the drawings, like numerals are used for like elements throughout.

A decoder 11 according to a preferred embodiment of the present invention will now be explained with reference to the drawings. The decoder 11 is employed in a data recording controller corresponding to a DVD+R/RW disc medium

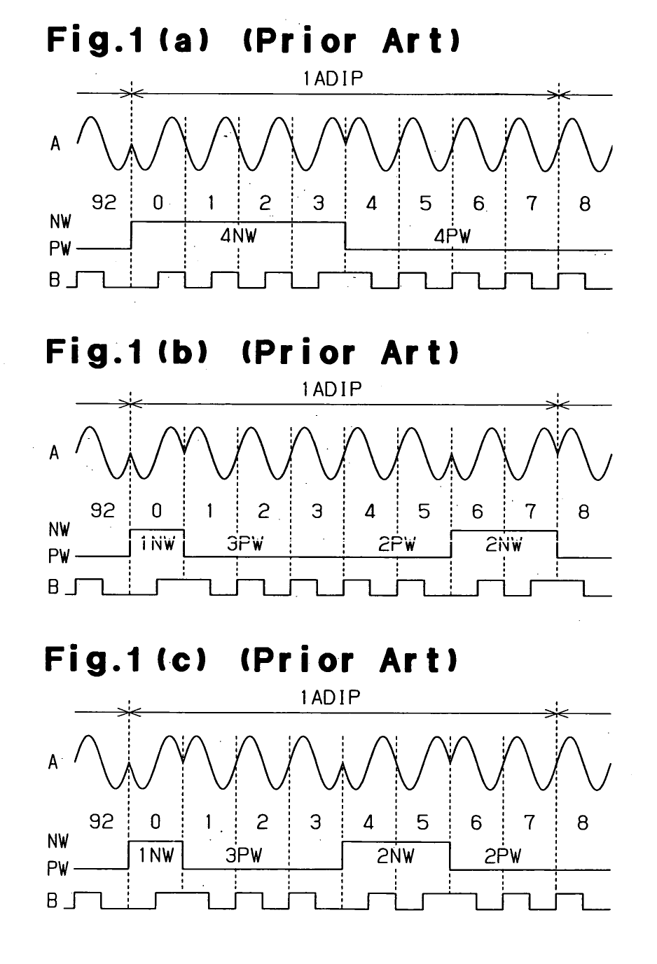

In the data recording controller, the DVD+R/RW, to which data is recorded, has a spiral pregroove functioning as a guide groove in the disk. The pregroove includes a meandering (wobble) component having predetermined cycle, and from such wobble component, a wobble signal having a frequency of “817.5 kHz” is acquired. Furthermore, in the pregroove, an ADIP, produced by phase-modulating the wobble component and representing physical positional information (address information) of the disc, is written to for example, 8 cycles of the wobble for every 93 cycles of the wobble (see FIGS. 1(a) to 1(c)).

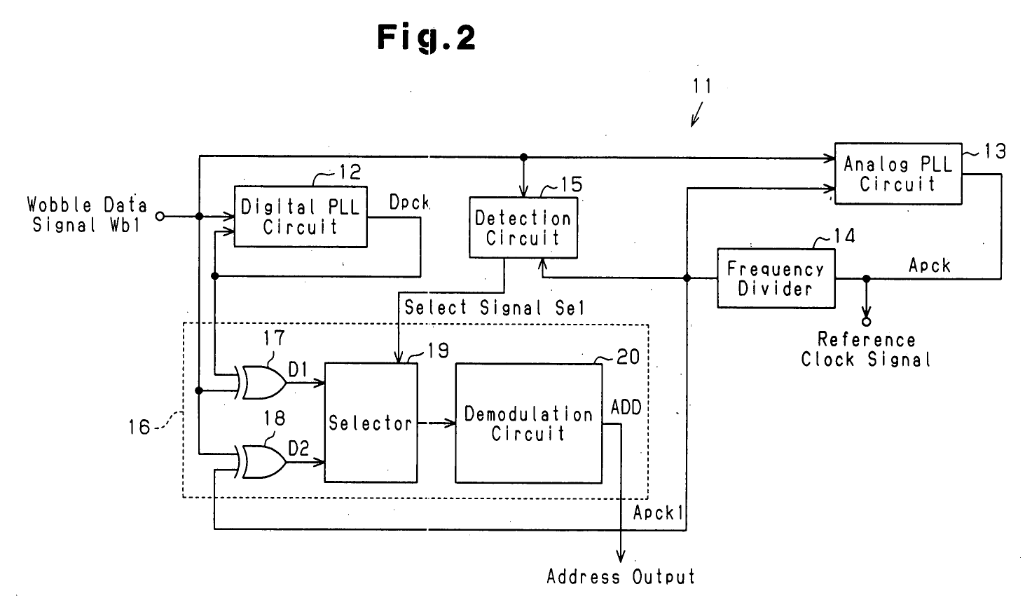

As shown in FIG. 2, the decoder 11 includes a digital PLL circuit 12, an analog PLL circuit 13, a frequency divider 14, a detection circuit 15, and a demodulator 16. The decoder 11 receives a wobble data signal Wbl obtained by binary coding a wobble signal read from the disc (DVD+R/RW in the present embodiment). The ADIP (address information) is superimposed on the leading 8 cycles in the 93 cycles of the wobble data signal Wbl.

The digital PLL circuit 12 generates a first clock signal Dpck and provides the first clock signal Dpck to a first exclusive OR circuit (hereinafter referred to as a first EOR gate) 17, which functions as a first phase detector and which is provided in the demodulator 16. Furthermore, the digital PLL circuit 12 determines the phase difference between the first clock signal Dpck and the reproduction data (more specifically, the wobble data signal Wbl), and feedback controls the first clock signal Dpck so that the first clock signal Dpck is synchronized with the wobble data signal Wbl based on the determined value.

The analog PLL circuit 13 generates a second clock signal Apck and provides the second clock signal Apck to a second exclusive OR circuit (hereinafter referred to as a second EOR gate) 18, which functions as a second phase detector and which is provided in the demodulator 16. Furthermore, the analog PLL circuit 13 generates a control voltage in accordance with the phase difference between the second clock signal Apck (to be more accurate, a divisional clock signal Apck1 of the second clock signal Apck) and the reproduction data (more specifically, the wobble data signal Wbl), and feedback controls the second clock signal Apck so that the second clock signal Apck is synchronized with the wobble data signal Wbl based on the control voltage.

The frequency divider 14 divides the frequency of the second clock signal Apck, which is provided from the analog PLL circuit 13, by a predetermined frequency dividing ratio (1/32 in the present embodiment) to generate the divisional clock signal Apck1, and provides the divisional clock signal Apck1 to the detection circuit 15, the analog PLL circuit 13, and the demodulator 16.

The demodulator 16 includes the first and second EOR gates 17 and 18, a selector 19, and a demodulation circuit 20.

The first EOR gate 17 receives the wobble data Wbl and the first clock signal Dpck, which is provided from the digital PLL circuit 12, and samples the wobble data signal Wbl in accordance with the first clock signal Dpck. To be more precise, the phase-inversion pattern of the ADIP included in the wobble data signal Wbl is detected by performing the exclusive OR operation on the wobble data signal Wbl and the first clock signal Dpck (see signal B in FIGS. 1(a) to 1(c)). In other words, the first EOR gate 17 determines whether the phase of the wobble data signal Wbl and the phase of the first clock signal Dpck coincide with each other, and generates the first detection signal D1 at a low (L) level if the signals coincide with each other, and generates the first detection signal D1 at a high (H) level if the signals do not coincide with each other (when the two phases invert).

The second EOR gate 18 receives the wobble data signal Wbl and the divisional clock signal Apck1, which is provided from the frequency divider 14, and samples the wobble data signal Wbl in accordance with the divisional clock signal Apck1. To be more precise, the phase-inversion pattern of the ADIP included in the wobble data signal Wbl is detected by performing an exclusive OR operation on the wobble data signal Wbl and the divisional clock signal Apck1 (see signal B in FIGS. 1(a) to 1(c)). In other words, the second EOR gate 18 determines whether the phase of the wobble data signal Wbl and the phase of the divisional clock signal Apck1 coincide with each other, and generates a second detection signal D2 at a low level if the signals coincide with each other, and generates the second detection signal at a high level if the signals do not coincide with each other (when the two phases invert).

The selector 19 responds to a select signal Sel, which is provided from the detection circuit 15, and selectively provides either the first detection signal D1 from the first EOR gate 17 or the second detection signal D2 from the second EOR gate 18 to the demodulation circuit 20. The demodulation circuit 20 receives either the first detection signal D1 or the second detection signal D2 from the selector 19 and demodulates the address information ADD based on the received detection signal.

In other words, the demodulation circuit 20 determines whether a certain ADIP is “SYNC”, “0”, or “1” with reference to the first detection signal D1 or the second detection signal D2, and converts each of the ADIP in that sector to the corresponding values. Normally, the ADIP corresponding to “SYNC” is assigned to the leading two frames of a sector, and the ADIP corresponding to either “0” or “1” is assigned to each of the following two frames. Therefore, by converting each ADIP in one sector (26 frames) to a corresponding value, address information ADD in which SYNC and twelve bits of “0” or “1” are continuous may be obtained.

The detection circuit 15 compares the wobble data signal Wbl and the divisional clock signal Apck1, and detects whether the second clock signal Apck is synchronized with the wobble data signal Wbl, or whether the analog PLL circuit 13 is locked. The detection circuit 15 then generates the select signal Sel in response to the detected result and provides the select signal Sel to the selector 19. For example, the detection circuit 15 generates the select signal Sel at a high level if the analog PLL circuit 13 is locked and generates the select signal Sel at a low level if the analog PLL circuit 13 is not locked.

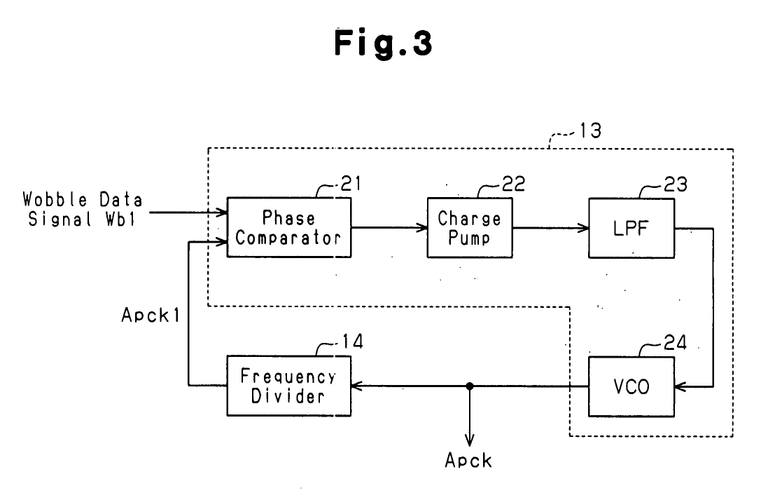

As shown in FIG. 3, the analog PLL circuit 13 includes a phase comparator 21, a charge pump 22, a low pass filter (hereinafter referred to as LPF) 23, and a voltage-controlled oscillator (hereinafter referred to as a VCO) 24.

The phase comparator 21 includes a first input terminal for receiving the wobble data signal Wbl and a second input terminal for receiving the divisional clock signal Apck1, which is generated in the frequency divider 14 by dividing the frequency of the second clock signal Apck (output signal of the analog PLL circuit 13) oscillated by the VCO 24. The phase comparator 21 compares the phase of the wobble data signal Wbl and the phase of the divisional clock signal Apck1 and provides a phase difference signal that is in accordance with the phase difference to the charge pump 22. The charge pump 22 then supplies the LPF 23 with current corresponding to the phase difference signal of the phase comparator 21. The LPF 23 supplies the VCO 24 with voltage that is in accordance with the output current of the charge pump 22. The VCO 24 oscillates in response to the output voltage of the LPF 23 and generates the second clock signal Apck.

In the analog PLL circuit 13, the output current of the charge pump 22 and the output voltage of the LPF 23 are varied in accordance with the phase difference signal of the phase comparator 21. This, in turn, accordingly varies the oscillation frequency of the VCO 24. By repeatedly carrying out such feedback operation, the analog PLL circuit 13 synchronizes the second clock signal Apck (to be more precise, the divisional clock signal Apck1 of the second clock signal Apck), which is provided from the VCO 24. with the wobble data signal Wbl.

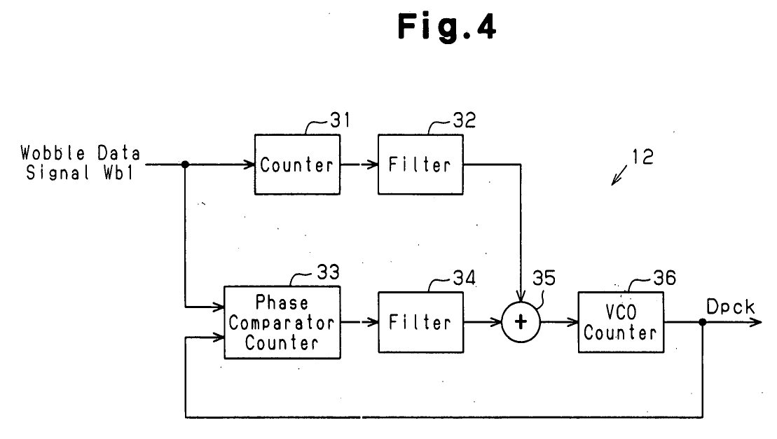

As shown in FIG. 4, the digital PLL circuit 12 includes a counter 31, a filter 32, a phase comparator counter 33, a filter 34, an adder 35, and a VCO counter 36.

The counter 31, which functions to detect the speed (frequency) of the wobble data signal Wbl, counts the cycles of the wobble data signal Wbl to detect the frequency of the wobble data signal Wbl. The filter 32 receives the output signal of the counter 31, or the counter output signal, filters the counter output signal, and provides the filtered counter output signal to the VCO counter 36 via the adder 35. In other words, if the frequency of the wobble data signal Wbl fluctuates slightly, the filter 32 cancels such slight fluctuation. This stabilizes the first clock signal output by the VCO counter 36.

The phase comparator counter 33 receives the wobble data signal Wbl and the first clock signal Dpck, which is output from the VCO counter 36, and compares the phase of the wobble data signal Wbl and the phase of the first clock signal Dpck. More specifically, the phase comparator counter 33 determines how much the phase of the first clock signal Dpck is advanced or delayed from the phase of the wobble data signal Wbl, and provides the output signal of the phase comparator counter 33, or the counter output signal (counter value), to the filter 34. The filter 34 filters the counter output signal of the phase comparator counter 33 and provides the filtered counter output signal to the VCO counter 36 via the adder 35. In the same manner as the filter 32, the filter 34 prevents the output signal of the VCO counter 36 from tracking a small phase difference between the wobble data signal Wbl and the first clock signal Dpck.

The adder 35 adds the filtered counter output signal from the filter 32 and the filtered counter output signal from the filter 34. The adder 35 then provides the added signal to the VCO counter 36. The VCO counter 36 corrects the frequency and the phase of the first clock signal Dpck in accordance with the added signal from the adder 35. The VCO counter 36 then synchronizes the first clock signal Dpck with the wobble data signal Wbl. The digital PLL circuit 12 has a superior tracking characteristic compared to the analog PLL circuit 13 and locks the first clock signal Dpck to the wobble data signal Wbl at high speed. In other words, the digital PLL circuit 12 synchronizes the first clock signal Dpck with the wobble data signal Wbl before the analog PLL circuit 13 generates the second clock signal Apck, which is synchronized with the wobble data signal Wbl.

The operation of the decoder 11 will now be explained.

When the wobble data signal Wbl, which is read from the disc and generated by binarization, is supplied to the decoder 11, the digital PLL circuit 12 and the analog PLL circuit 13 respectively generate the first clock signal Dpck and the second clock signal Apck that are synchronized with the—wobble data signal Wbl.

The first EOR gate 17 detects the phase inversion pattern of the ADIP included in the wobble data signal Wbl based on the first clock signal Dpck, and provides the first detection signal D1 to the selector 19. The second EOR gate 18 detects the phase inversion pattern of the ADIP included in the wobble data signal Wbl based on the second clock signal Apck, and provides the second detection signal D2 to the selector 19.

In response to, for example, a low select signal Sel from the detection circuit 15, the selector 19 selects the first detection signal D1 provided from the first EOR gate 17. The demodulation circuit 20 demodulates the address information ADD based on the first detection signal D1.

The detection circuit 15 detects whether the second clock signal Apck from the analog PLL circuit 13 is synchronized with the wobble data signal Wbl, that is, whether the analog PLL circuit 13 is locked. If the analog PLL circuit 13 is locked, the detection circuit 15 provides the selector 19 with a high select signal Sel.

The selector 19 responds to the high select signal Sel and selects the second detection signal D2 from the second EOR gate 18. The demodulation circuit 20 thus demodulates the address information ADD based on the second detection signal D2.

In this manner, the address information ADD is demodulated based on the phase inversion pattern that is detected with the first clock signal Dpck of the digital PLL circuit 12 until the analog PLL circuit 13 is locked. After the analog PLL circuit 13 is locked, the address information ADD is demodulated based on the phase inversion pattern detected with the second clock signal Apck (more specifically, the divisional clock signal Apck1) of the analog PLL circuit 13.

The decoder 11 of the present embodiment has the advantages described below.

(1) The decoder 11 demodulates the address information ADD based on the phase inversion pattern of the ADIP detected with the first clock signal Dpck of the digital PLL circuit 12 until the analog PLL circuit 13 is locked. After the analog PLL circuit 13 is locked, the address information ADD is demodulated based on the phase inversion pattern detected with the second clock signal Apck of the analog PLL circuit 13. With such configuration, the address information ADD is demodulated using the first clock signal Dpck of the digital PLL circuit 12, which has a superior tracking characteristic, until the second clock signal Apck locks with the wobble data signal Wbl. After the second clock signal Apck is locked with the wobble data signal Wbl, the second clock signal Apck of the analog PLL circuit 13, which has a superior phase-noise characteristic, is used to demodulate the address information ADD. Therefore, the demodulation of the address information ADD included in the wobble data signal Wbl is performed efficiently.

(2) The area of the analog PLL circuit 13 is prevented from increasing. This prevents the circuit area of the entire decoder 11 from increasing and saves costs.

It should be apparent to those skilled in the art that the present invention may be embodied in many other specific forms without departing from the spirit or scope of the invention. Particularly, it should be understood that the invention may be embodied in the following forms.

In FIG. 2, the frequency divider 14 may be included in the analog PLL circuit 13.

The frequency divider 14 may be omitted, and the detection circuit 15 may compare the wobble data signal Wbl and the second clock signal Apck from the analog PLL circuit 13 to detect whether the analog PLL circuit 13 is locked.

A voltage output type charge pump may be used in place of the current output type charge pump 22.

The present invention may be applied to any disc medium other than a DVD+R/RW.

Therefore, the present examples and embodiments are to be considered as illustrative and not restrictive and the invention is not to be limited to the details given herein, but may be modified within the scope andequivalence of the appended claims.

What is claimed is:

1. A decoder for demodulating address information using a wobble signal, the decoder comprising:
a digital PLL circuit for generating a first clock signal and synchronizing the first clock signal with the wobble signal based on a difference between the phase of the wobble signal and the phase of the first clock signal;
an analog PLL circuit for generating a second clock signal and synchronizing the second clock signal with the wobble signal based on a difference between the phase of the wobble signal and the phase of the second clock signal; and
a demodulator, connected to the digital PLL circuit and the analog PLL circuit, for sampling the wobble signal using either the first clock signal or the second clock signal to demodulate the address information.

2. The decoder as claimed in claim 1, further comprising a detection circuit for comparing the wobble signal and the second clock signal and detecting whether the second clock sianal is synchronized with the wobble signal, wherein the demodulator selects either the first clock signal or the second clock signal based on a detection result of the detection circuit.

3. The decoder as claimed in claim 2, wherein the analog PLL circuit includes:
a phase comparator for generating a phase difference signal in response to a difference between the phase of the wobble signal and the phase of a divisional clock signal generated by dividing the frequency of the second clock signal by a predetermined frequency dividing ratio;
a charge pump, connected to the phase comparator, for generating current in accordance with the phase difference signal;
a low pass filter, connected to the charge pump, for generating voltage in accordance with the current of the charge pump; and
a voltage-controlled oscillator, connected to the low pass filter, for oscillating in accordance with the voltage of the low pass filter and generating the second clock signal, wherein the detection circuit compares the wobble signal and the divisional clock signal and detects whether the second clock signal is synchronized with the wobble signal.

4. The decoder as claimed in claim 1, wherein the demodulator samples the wobble signal using the first clock signal until the second clock signal is synchronized with the wobble signal and samples the wobble signal using the second clock signal after the second clock signal is synchronized with the wobble signal.

5. The decoder as claimed in claim 1, wherein the demodulator includes:
a first phase detector, connected to the digital PLL circuit, for detecting a phase inversion of the wobble signal based on the first clock signal; and
a second phase detector, connected to the analog PLL circuit, for detecting a phase inversion of the wobble signal based on the second clock signal.

6. The decoder as claimed in claim 5, wherein the demodulator includes a selector, connected to the first and second phase detectors, for selecting either the detected result of the first phase detector or the detected result of the second phase detector in accordance with a select signal.

7. A decoder for demodulating address information using a wobble signal, the decoder comprising:
a digital PLL circuit for generating a first clock signal and synchronizing the first clock signal with the wobble signal based on a difference between the phase of the wobble signal and the phase of the first clock signal;
an analog PLL circuit for generating a second clock signal and synchronizing the second clock signal with the wobble signal based on a difference between the phase of the wobble signal and the phase of the second clock signal;
a detection circuit for comparing the wobble signal and the second clock signal, detecting whether the second clock signal is synchronized with the wobble signal, and generating an active select signal when the second clock signal is synchronized with the wobble signal; and
a demodulator, connected to the digital PLL circuit, the analog PLL circuit, and the detection circuit, for sampling the wobble signal using the first clock signal to demodulate the address information when the select signal is inactive and for sampling the wobble signal using the second clock signal to demodulate the address information when the select signal is active.

8. The decoder as claimed in claim 7, wherein the demodulator includes:
a first phase detector, connected to the digital PLL circuit, for detecting a phase inversion of the wobble signal based on the first clock signal and generating a first phase detection signal;
a second phase detector, connected to the analog PLL circuit, for detecting a phase inversion of the wobble signal based on the second clock signal and generating a second phase detection signal;
a selector, connected to the first and second phase detectors and the detection circuit, for selecting the first phase detection signal in response to the inactive select signal and selecting the second phase detection signal in response to the active select signal; and
a demodulator circuit, connected to the selector, for demodulating the address information using the selected phase detection signal.
